(19) United States
(12) Patent Application Publication
(10) Pub. No.: US 2002/0073359 A1
(43) Pub. Date: Jun. 13, 2002

(54) System and method for high priority machine check analysis

(76) Inventor: Jennifer A. Wade, Fort Collins, CO (US)

Correspondence Address: HEWLETT-PACKARD COMPANY, Intellectual Property Administration, P. O. Box 272400, Fort Collins, CO, 80527-2400, US

(21) Appl. No.: 09/947,824

(22) Filed: Sep. 6, 2001

Related U.S. Application Data
(60) Provisional application No. 60/231,288, filed on Sep. 8, 2000.

(51) Int. Cl. G06F 11/26

(52) U.S. Cl. 714/37

(57) ABSTRACT

In one embodiment, the present invention is directed to a system for providing analysis information pertaining to a high priority machine check (HPMC). The system may comprise a processor that is operable to invoke utility code when an HPMC is generated. The system may further comprise non-volatile memory for storing said utility code, said utility code comprising: code for accessing data present in internal memory of said processor when said HPMC was generated and code for generating at least one explanatory sentence utilizing at least said data present in said internal memory.

### RELATED APPLICATIONS

This application is related to and claims the benefit of provisional application serial No. 60/231,288, filed Sep. 8, 2000, entitled “ROM RESIDENT HIGH PRIORITY MACHINE CHECK ANALYSIS TOOL,” which is incorporated herein by reference.

### BACKGROUND OF THE INVENTION

Micro-processors typically include processor internal memory. Processor internal memory allows improved access to various data by the processor. Processor internal memory may be utilized for various tasks that benefit from improved access. For example, general data registers, floating point data registers, and control data registers may be included in processor internal memory to facilitate various processing operations. Additionally, processor internal memory may include registers to retain various state-related information associated with the processor. In a similar manner, other components (e.g., memory controllers or various adapters) of a computer system may retain state-related information.

When various errors of appreciable significance occur in a computer system, a High Priority Machine Check (HPMC) is generated. An HPMC is an exception that is utilized to identify hardware-level errors associated with a computer system. Errors related to HPMCs are generally non-recoverable, i.e., the computer system is unable to correct the error and must reboot. An example of a potential HPMC is a data parity error. For example, a processor may retrieve data from memory. The processor may determine that the retrieved data possesses at least two bit errors via a polynomial encoding algorithm or a parity encoding algorithm depending on the processor's architecture. However, the encoding algorithm may only enable correction of one bit error. Accordingly, the processor is unable to correct this error and an HPMC may be generated.

When an HPMC is generated, it is frequently desirable to determine the source of the error for root cause analysis and/or for replacement of parts. Accordingly, existing systems provide an HPMC handler or utility. Upon occurrence of an HPMC, various instructions defining the operations of the HPMC utility are retrieved from firmware or processor-dependent code. The various instructions typically write pertinent contents of processor internal memory and system-state information to non-volatile memory (e.g., EEPROM). Specifically, the various instructions write the values stored in the registers associated with processor internal memory as a “hex-dump” to the non-volatile memory. FIGS. 1A and 1B depict an example of hex-dump 100 according to existing art. Hex-dump 100 provides numerous fields including the hexadecimal values of the general registers, control registers, space registers, and floating point registers as examples. Hex-dump 100 may also include other hexadecimal values for other pertinent processor related information such as CPU State, Path Info, System Responder Address, System Requestor Address, and/or the like.

A field engineer may examine hex-dump 100 at a later time in an effort to determine the source of the hardware-level error. Experienced field engineers may be capable of determining the likely cause of the HMPC solely by inspection of the hex-dump. However, the hex-dump differs from product to product and an experienced field engineer is not always available. Moreover, different processors may utilize different hex-values to represent the same state. Accordingly, it is frequently necessary to access a separate resource to interpret hex-dump 100. For example, a field engineer may access a website, a technical manual or document, and/or a separate analysis utility associated with a particular HMPC utility. Each of these external resources essentially provide a table format of information. The analysis utility is believed to be somewhat interactive. Specifically, it is believed that the analysis utility provides successive instructions to a field engineer to assist the engineer's analysis of the hex-dump information. However, the field engineer is believed to be required to locate and correctly interpret the pertinent information.

The use of these external resources is problematic in many respects. First, even with assistance of the external resources, the hex-dump analysis is often too time-consuming. Moreover, a separate resource is not always accessible. Even if access to the separate resource is possible, a field engineer may not appreciate the relevance of the provided information and may not be able to determine which components to replace. As a result of these problems, it has been found that field engineers frequently attempt to replace a number of components until the computer system becomes operational again. By replacing several parts, of which only one may be defective, maintenance costs and warranty costs are increased. In addition, if the external resources do not prove helpful to the field engineer, the analysis may be escalated by having others, such as, research and development (R/D) engineers analyze the HMPC information thereby adding expense.

### BRIEF SUMMARY OF THE INVENTION

In one embodiment, the present invention is directed to a system for providing analysis information pertaining to a high priority machine check (HPMC). The system may comprise a processor that is operable to invoke utility code when an HPMC is generated. The system may further comprise non-volatile memory for storing said utility code, said utility code comprising: code for accessing data present in internal memory of said processor when said HPMC was generated and code for generating at least one explanatory sentence utilizing at least said data present in said internal memory.

### BRIEF DESCRIPTION OF THE DRAWINGS

FIGS. 1A and 1B depict a processor internal memory hex-dump according to existing art.

FIG. 2 depicts an exemplary computer system on which embodiments of the present invention may be implemented.

FIG. 3 depicts an exemplary flowchart related to processor internal memory analysis and system state information related to a high priority machine check.

FIGS. 4A and 4B depict an exemplary processor internal memory and system state information analysis according to an embodiment of the present invention.

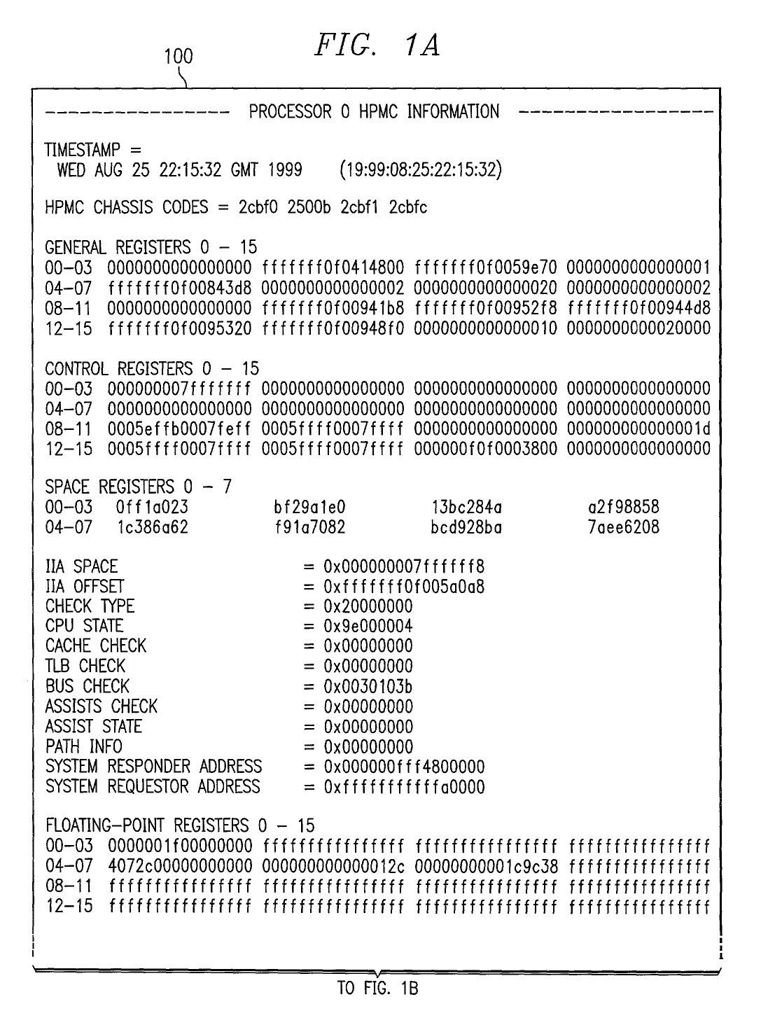

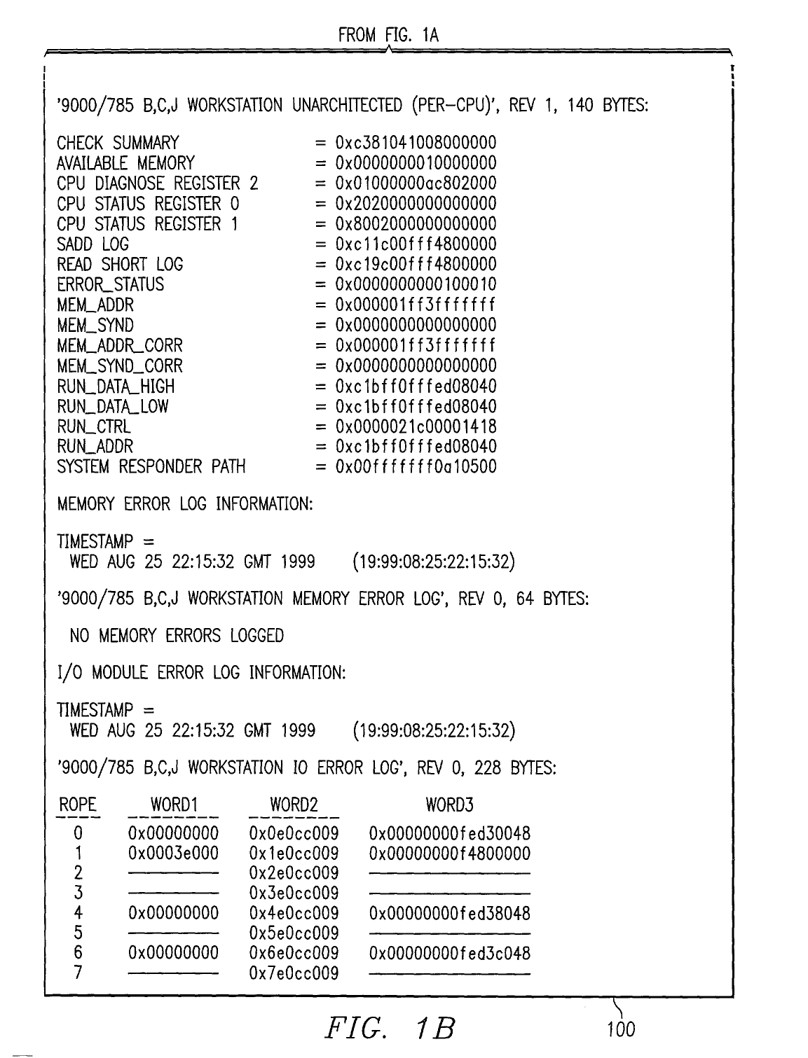

### DETAILED DESCRIPTION OF THE INVENTION

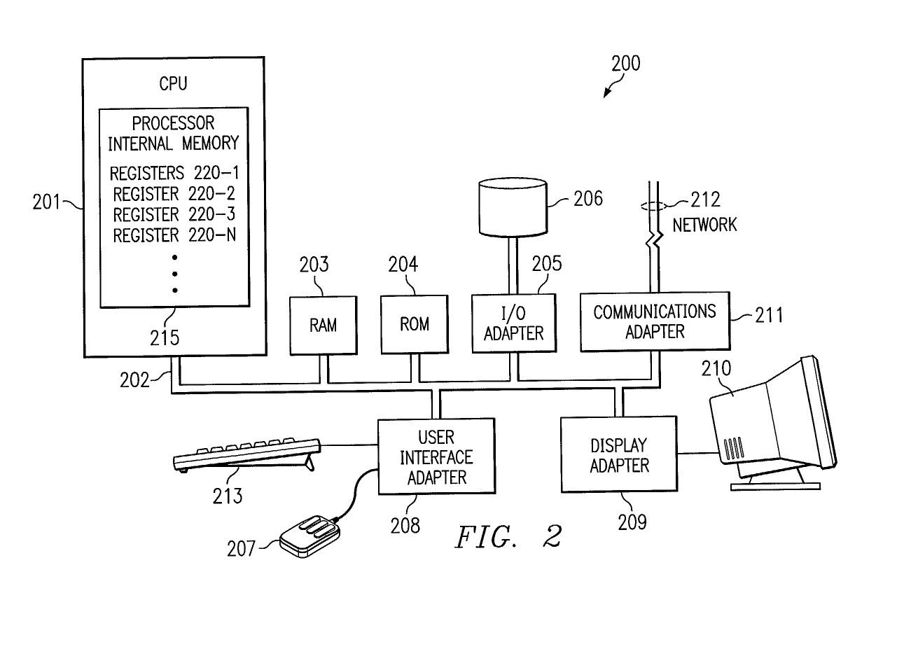

FIG. 2 depicts exemplary computer system 200 on which embodiments of the present invention may be implemented. Computer system 200 includes central processing unit (CPU) 201. CPU 201 may be any general purpose CPU. Suitable processors, without limitation, include any processor from the ITANIUM® family of processors or a PA-8500, PA-8600, or PA-8700 processor available from Hewlett-Packard Company. However, the present invention is not restricted by the architecture of CPU 201 as long as CPU 201 supports the inventive operations as described herein. Additionally, it shall be appreciated that the present invention is not limited to single processor architectures. For example, the present invention may be advantageously implemented on multi-processor server platforms.

CPU 201 comprises processor internal memory 215. Processor internal memory 215 comprises registers 220-1 through 220-N. Registers 220-1 through 220-N may comprise any number of general purpose registers to allow software processes to manipulate various variables in an efficient manner. General purpose registers are typically viewable to all programs at all privilege levels. Likewise, registers 220-1 through 220-N may include any number of floating point registers if floating point operations are supported. Registers 220-1 through 220-N may comprise any number of control registers and/or space registers. Control registers may facilitate various processor control tasks and space registers may be used for virtual addressing.

Internal memory 215 may be utilized to hold any number of additional pertinent processor state information. For example, internal memory 215 may comprise a register or series of registers referred to as processor status word (PSW). PSW is used to represent the current state of a processor. Moreover, internal memory 215 may be sufficiently large to hold additional information in a data cache or an instruction cache. For example, program instructions or program data or portions thereof may be loaded into processor internal memory to facilitate the operations of a program or programs according to code prediction algorithms.

CPU 201 may be interrupt-driven. Specifically, this means that CPU 201 checks for various interrupts before it performs the execution steps of its instruction cycle. An instruction cycle refers to various steps that CPU 201 performs each time it retrieves an instruction from a program and executes an operation for that cycle. When a hardware-level error occurs, a unit of computer system 200 may cause a register value of CPU 201 to be set to a particular value. For example, and without limitation, systems utilizing a PA-8500 processor set the PSW bit “M” to “1” to indicate that a hardware-level error has occurred and the systems also mask further occurrences. Upon the fetch and execution cycle of the instruction cycle, the PA-8500 processor checks the “M” bit of the PSW. If the “M” bit of the PSW is set to “1”, the PA-8500 processor executes a hardware interrupt. The hardware interrupt is utilized to invoke the High Priority Machine Check (HPMC) utility (a program stored in non-volatile memory as will be discussed in greater detail below).

Moreover, CPU 201 is coupled to system bus 202. Computer system 200 also includes random access memory (RAM) 203, which may be SRAM, DRAM, SDRAM, or the like. RAM 203 may be associated with a memory controller (not shown) to control read and write operations to memory locations within RAM 203. Computer system 200 includes ROM 204 which may be PROM, EPROM, EEPROM, or the like. ROM 204 comprises the various non-volatile memory components of the system, such as those that store system and program data or processor-dependent code (PDC). RAM 203 and ROM 204 hold user and system data and programs as is well known in the art. Additionally, non-volatile memory such as ROM 204 may be utilized to store the processor internal memory analysis information. For example, a predetermined segment of ROM 204 may be assigned to store explanatory sentences generated by processor internal memory analysis after the occurrence of an HPMC. The size of the predetermined segment may be varied according to the number of processors in computer system 200 and the complexity of the explanatory sentences.

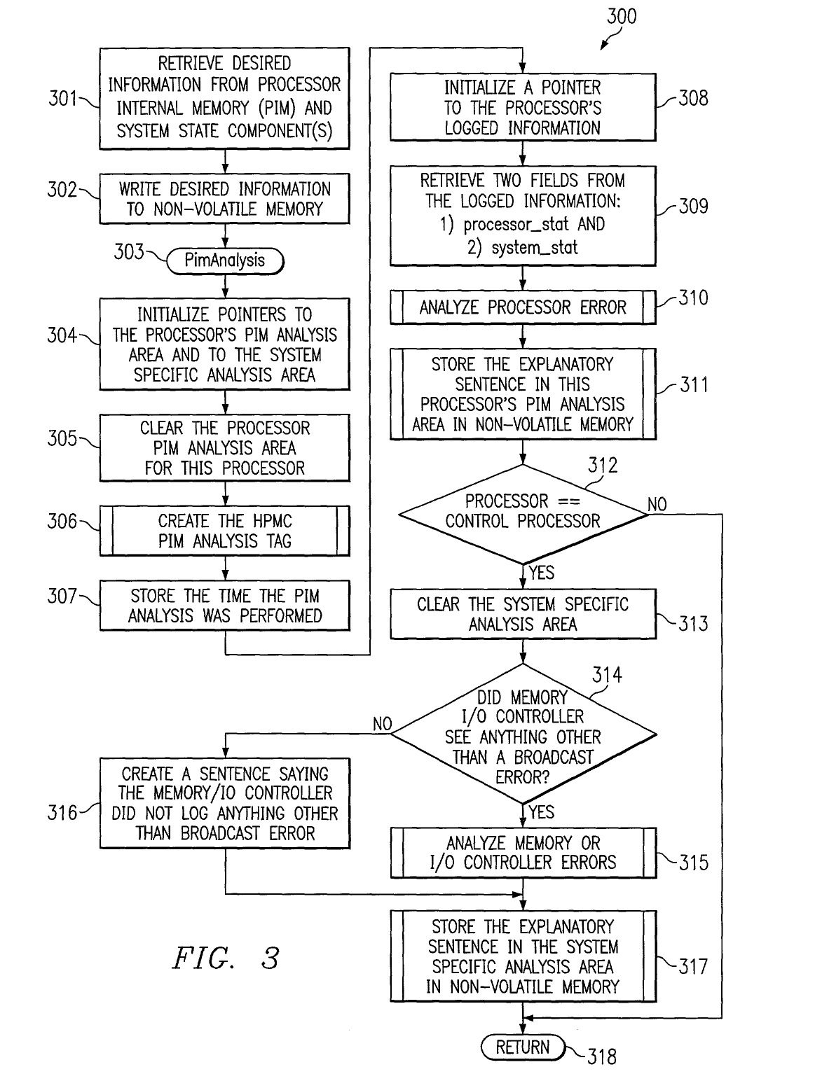

In accordance with embodiments of the present invention, firmware or processor-dependent code may be stored on ROM 204. The firmware or processor-dependent code (PDC) may comprise instructions or code for an HPMC utility and a processor internal memory analysis utility. The utilities may be referred to as ROM-resident in that they are compiled with the other portions of the PDC. The HMPC utility may write various contents of processor internal memory to non-volatile memory. For example, the HPMC utility may write the contents of processor internal memory to a predetermined segment of ROM 204. Moreover, according to the present invention, the processor internal memory analysis utility may create explanatory information as will be discussed in greater detail with respect to FIG. 3. To facilitate recovery of the explanatory information, the processor internal memory analysis utility may also advantageously write the explanatory information to non-volatile memory such as ROM 204. Because the explanatory information is generated by the processor internal memory analysis utility which is ROM-resident, no external tools are necessary to diagnose HPMC data.

Computer system 200 also includes input/output (I/O) adapter 205, communications adapter 211, user interface adapter 208, and display adapter 209. I/O adapter 205 connects to storage devices 206, such as one or more of hard drive, CD drive, floppy disk drive, and tape drive, to computer system 200. Communications adapter 211 is adapted to couple computer system 200 to network 212, which may be one or more of telephone network, local (LAN), wide-area (WAN) network, Ethernet network, and/or Internet network. User interface adapter 208 couples user input devices, such as keyboard 213 and pointing device 207, to computer system 200. Display adapter 209 is driven by CPU 201 to control the display on display device 210.

Any of the preceding components of computer system 200 may be the cause of an HPMC. For example, system bus 202 may be a peripheral component interconnect (PCI) bus. Accordingly, various components may be associated with PCI bus slots. One of the components may be improperly installed on the PCI bus. The improper installation may cause a data input/output (I/O) fetch timeout error to thereby generate an HPMC. It shall be appreciated that a particular cause of an HPMC depends on the respective system. Any numerous other components included in respective computers systems may generate an HPMC to be analyzed according to embodiments of the present invention.

As previously noted, when an HPMC is generated, CPU 201 may generate an interrupt to invoke the HPMC utility. The HMPC utility may perform various steps to retrieve information from processor internal memory and system state components (e.g, RAM 203 or I/O adapter 205) and to write the information to non-volatile memory. The HPMC may then call a processor internal memory analysis tool that will analyze the information to generate explanatory information. The explanatory information may also be written to non-volatile memory.

Although the preceding has described HPMC analysis in computer systems, the present invention is not limited to any particular architecture. The present invention may be employed in any suitable processor-based device that generates HPMC's. For example and without limitation, the present invention may be implemented by personal data assistants (PDAs), printers, scanners, storage devices, and/or the like.

FIG. 3 depicts an exemplary flowchart 300 of steps that may be performed by an HPMC utility and an embodiment of a processor internal memory analysis utility according to the teachings of the present invention. The steps of flowchart 300 may preferably be implemented in executable instructions or code stored in non-volatile memory. In accordance with embodiments of the invention, the code may be advantageously compiled with the other portions of the firmware or processor-dependent code. By associating the code with other portions of the firmware or processor-dependent code, it is possible to ensure that the explanatory information is consistent with any revisions to the system.

In step 301, the HPMC utility begins after being invoked by a hardware interrupt by CPU 201. The HPMC utility retrieves desired information from processor internal memory 215. The HPMC preferably also retrieves desired system state information from various components such as RAM 203 and I/O adapter 205. In step 302, the HPMC utility writes or logs the raw information to non-volatile memory. Steps 301 and 302 are steps typically performed by prior art HPMC utilities. At this point, the HPMC utility preferably calls a processor internal memory analysis tool (step 303) to perform various steps according to embodiments of the present invention.

The processor internal memory analysis tool may first initialize pointers to a processor internal memory (PIM) analysis area and to a system specific analysis area to perform the processing associated with the desired analysis (step 304). These areas preferably are predefined portions of non-volatile memory where appropriate explanatory information may be written. In step 305, the PIM analysis area is cleared. In step 306, an HPMC PIM analysis tag is created, i.e., a string that will be used as a header for the explanatory information. In step 307, the time that the analysis was performed is stored. A pointer to CPU 201's information that was previously logged by the HPMC utility is initialized (step 308). In step 309, two fields (processor_stat and system_stat) are retrieved from the information that was logged in step 302. The processor_stat field holds information retrieved from a register or registers associated with processor internal memory that defines the error state of CPU 201. Similarly, the system_stat field holds information retrieved from an error register or registers associated with system state components such as a memory controller or an I/O controller.

In step 310, the processor error is analyzed by examination of the processor_stat field. Various sentences may be created for different errors. For example, the analysis may be performed by switch statements or conditions. The various case-lines of a switch statement may define the code that is performed for each given error. Potential error types may include a timeout error, a synchronization error, a data or address parity error, a broadcast error, a request error, a response error, and/or the like. It shall be appreciated that the enumerated error types are merely examples. The specific errors applicable to a given PIM analysis utility may be determined by reference to the defined error register states of the processor selected for a respective computer system. Also, a default error type may be defined for error types that do not fall within the other defined categories.

The type of error may be reflected in a first portion of an explanatory sentence. The second portion of the explanatory sentence may be generated from other various information previously retrieved by the HPMC utility. The second portion may identify a specific processor (if the system is a multi-processor system), I/O path, device, component, and/or address associated with the BPMC. The second portion may be dependent on the type of error produced. For example, if a data parity error occurred, the memory address associated with the data parity error may be provided in the second portion of the explanatory sentence. Likewise, if a timeout error occurred, the bus slot associated with the timeout error may be identified. By providing both the type of error and related information in the explanatory sentence, a field engineer is not required to cull through all of the information in a hex-dump. Moreover, the field engineer is not required to know which register fields are relevant to the HPMC when a specific type of error occurs. Accordingly, embodiments of the present invention allow less-experienced field engineers to take appropriate remedial steps to return computer systems to operational status.

In step 311, the explanatory sentence or sentences are preferably stored in PIM analysis area in non-volatile memory.

The steps following step 312 may preferably only be performed by one processor in a multi-processor system. Step 312 determines whether the processor currently executing is designated as the control processor (the processor designated to log system state information). By performing step 312, unnecessary duplication of system state analysis by other processors in the system may be avoided. If the processor currently executing is not designated to log system state information, the processor internal memory analysis tool proceeds to step 318 thereby omitting unnecessary analysis of the memory controller or I/O controller. Otherwise, the system-specific analysis area is cleared (step 313). In step 314, the system_stat field is examined to determine whether the memory or I/O controller observed anything other than a broadcast error. If so, an analysis of the error from the perspective of the memory or I/O controller is performed (step 315). If not, a explanatory sentence is created to the effect that the memory or I/O controller only observed a broadcast error (step 316). The analysis of the memory or I/O controller error may occur in a manner that is similar to the processor error. For example, one or more switch statements may be utilized. The various case-lines may provide a portion of an explanatory sentence related to a defined error state as reflected in the respective register(s) of the memory or I/O controller. The explanatory sentence or sentences generated from the perspective of the memory or I/O controller are preferably written into an appropriate location in non-volatile memory (step 317). In step 318, the processor internal memory analysis tool exits by executing a return operation.

It shall be appreciated that various components of a computer system retain state information that may be beneficial in determining the source of the error. Each component of the system (e.g. processor, memory controller, I/O controller, and/or the like) retains information associated with the error from its perspective. To accurately describe an error, it is frequently appropriate to examine the error from each component's perspective.

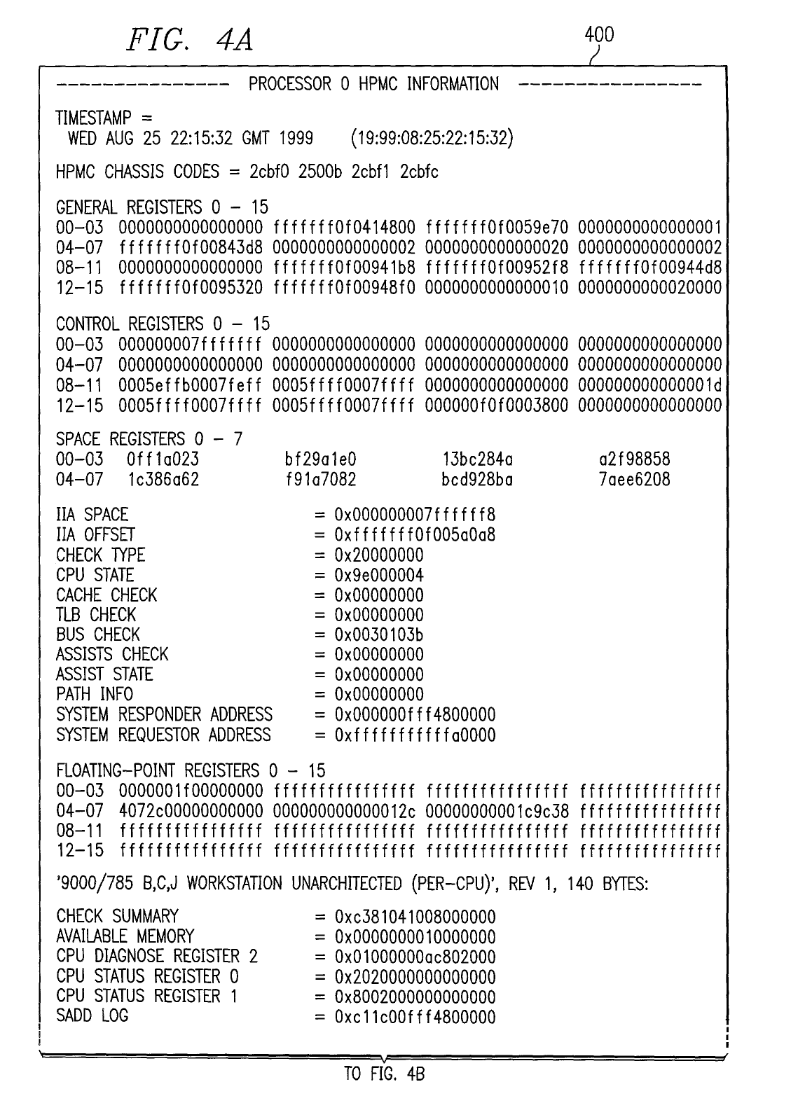

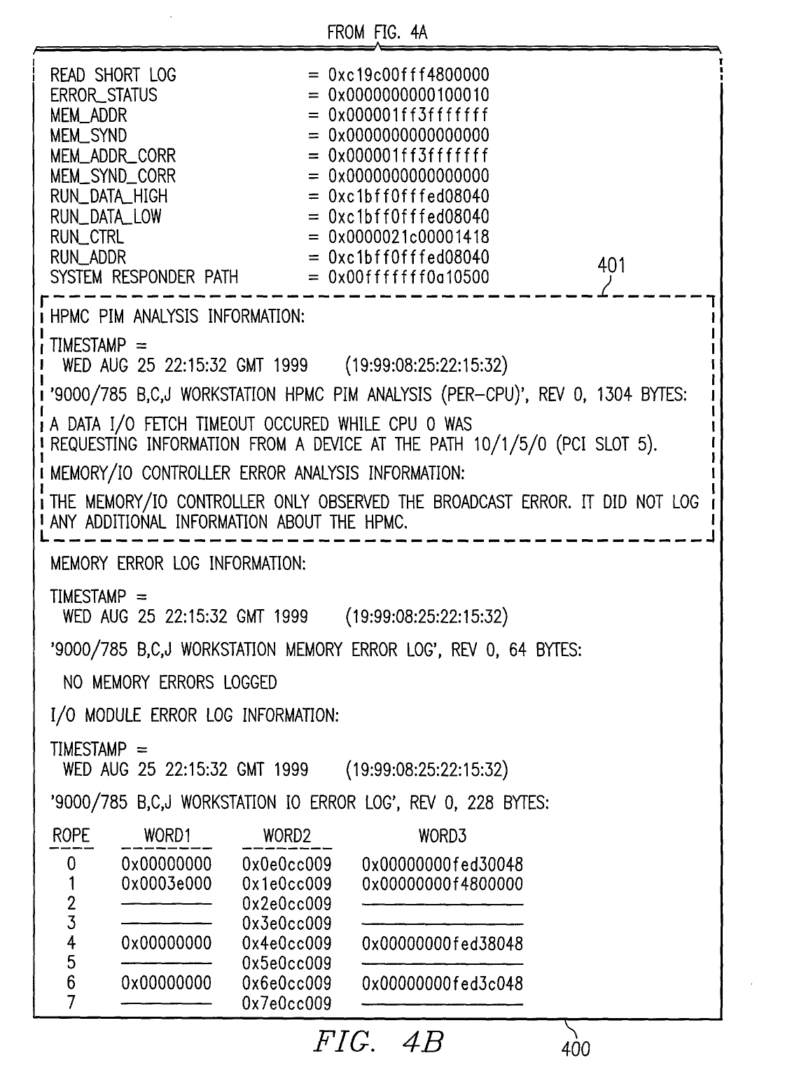

The explanatory information may be viewed at another time through a number of mechanisms. For example, a user interface such as a boot console handler (BCH), an operating system (OS) retrieval command, and/or a diagnostic retrieval command may be invoked to display the processor internal memory analysis information. FIGS. 4A and 4B depict an exemplary output from such a display mechanism according to embodiments of the present invention. PIM analysis information 400 may comprise the typical information that is seen in prior art PIM information. According to the teachings of the present invention, PIM analysis information 400 also comprises explanatory section 401. Section 401 comprises an explanatory sentence or sentences that allow a user to quickly understand the source of the HPMC error. In this case, the source of the HPMC was described by the sentence: “A DATA I/O FETCH TIMEOUT OCCURRED WHILE CPU 0 WAS REQUESTING INFORMATION FROM A DEVICE AT THE PATH 10/1/5/0 (PCI SLOT 5).”

In alternative embodiments, the explanatory sentence or sentences may include other information. For example, the explanatory sentence may provide instructions to a field engineer such as “CHECK THAT THE DEVICE ON PCI SLOT 5 IS PROPERLY INSTALLED. IF IT IS PROPERLY INSTALLED AND THE PROBLEM PERSISTS, REPLACE THE DEVICE.” Also, the explanatory sentence or sentences may list components of computer system 201 that may require testing and/or replacement to remedy the HPMC.

It shall be appreciated that embodiments of the present invention possess several advantages over prior art analysis of processor internal memory data. First, embodiments of the present invention do not require an external source to interpret the data. Explanatory sentences may be provided to allow any field engineer who possesses moderate technical knowledge to begin remedial steps. Field engineers are not required to correlate information from various hex-dump fields. Instead, the explanatory sentence(s) may contain each portion of pertinent data in a single location for a particular type of HPMC.

Additionally, the explanatory sentences may identify specific components and/or I/O slots associated with an HPMC. By improving the quality of information provided to field engineers, the amount of time spent repairing malfunction systems may be appreciably reduced. Moreover, embodiments of the present invention reduce the probability that non-malfunctioning components of a system will be replaced as the result of trial-and-error repairs by field engineers. Additionally, field engineers will not be confused by referring to out-of-date information. Specifically, the processor internal memory analysis tool is preferably compiled at the time that the other portion of the firmware or the processor-dependent code is compiled. Accordingly, the manufacturer may ensure that the explanatory data matches the system revision.

1. A system for providing analysis information pertaining to a high priority machine check (HPMC), comprising:
a processor that is operable to invoke utility code when an HPMC is generated;
non-volatile memory for storing said utility code, said utility code comprising:
code for accessing data present in internal memory of said processor when said HPMC was generated; and
code for generating at least one explanatory sentence utilizing at least said data present in said internal memory.

2. The system of claim 1 wherein said utility code further comprises:
code for accessing data associated with a memory controller when said HPMC was generated; and
code for generating at least one explanatory sentence utilizing at least said data present in said memory controller when said HPMC was generated.

3. The system of claim 1 wherein said utility code further comprises:
code for accessing data associated with an input/output (I/O) controller when said HPMC was generated; and
code for generating at least one explanatory sentence utilizing at least said data present in said I/O controller when said HPMC was generated.

4. The system of claim 1 wherein said at least one explanatory sentence identifies an error selected from the list of: a timeout error, a synchronization error, a data parity error, an address parity error, a broadcast error, a request error, and a response error.

5. The system of claim 1 wherein said at least one explanatory sentence identifies a bus slot associated with said HPMC.

6. The system of claim 1 wherein said at least one explanatory sentence identifies a memory address associated with said HPMC.

7. The system of claim 1 wherein said at least one explanatory sentence suggest a component for replacement.

8. The system of claim 1 wherein said at least one explanatory sentence is human-readable.

9. A method for providing analysis information pertaining to a high priority machine check (HPMC), comprising the steps of:
detecting that an HPMC has occurred;
invoking an analysis utility;
accessing data associated with processor internal memory of a processor by said analysis utility; and
generating at least one explanatory sentence utilizing at least said data present in said internal memory.

10. The method of claim 9 further comprising the steps of:
accessing data associated with a memory controller when said HPMC occurred; and
generating at least one explanatory sentence utilizing at least said data present in said memory controller when said HPMC occurred.

11. The method of claim 9 further comprising the steps of:
accessing data associated with an input/output (I/O) controller when said HPMC occurred; and
generating at least one explanatory sentence utilizing at least said data present in said I/O controller when said HPMC occurred.

12. The method of claim 9 wherein said generating at least one explanatory sentence identifies an error selected from the list of: a timeout error, a synchronization error, a data parity error, an address parity error, a broadcast error, a request error, and a response error.

13. The method of claim 9 wherein said at least one explanatory sentence identifies a bus slot associated with said HPMC.

14. The method of claim 9 wherein said at least one explanatory sentence identifies a memory address associated with said HPMC.

15. The method of claim 9 wherein said at least one explanatory sentence identifies at least one potential component for replacement.

16. A system for providing analysis information pertaining to a high priority machine check (HPMC), comprising:
means for invoking utility code stored in non-volatile memory when an HPMC is generated;
means for accessing data present in internal memory of a processor when said HPMC was generated; and
means for generating at least one explanatory sentence utilizing at least said data present in said internal memory.

17. The system of claim 16 further comprising:
means for accessing data associated with a memory controller when said HPMC was generated; and
means for generating at least one explanatory sentence utilizing at least said data present in said memory controller when said HPMC was generated.

18. The system of claim 16 further comprising:
means for accessing data associated with an input/output (I/O) controller when said HPMC was generated; and
means for generating at least one explanatory sentence utilizing at least said data present in said I/O controller when said HPMC was generated.

19. The system of claim 16 wherein said at least one explanatory sentence identifies an error selected from the list of: a timeout error, a synchronization error, a data parity error, an address parity error, a broadcast error, a request error, and a response error.

20. The system of claim 16 wherein said at least one explanatory sentence identifies a bus slot associated with said HPMC.

21. The system of claim 16 wherein said at least one explanatory sentence identifies a memory address associated with said HPMC.
